(19) United States
(12) Patent Application Publication
(10) Pub. No.: US 2024/0141702 A1
(43) Pub. Date: May 2, 2024

(54) ENTRY DOOR EXTENSION HANDLE

(71) Applicant: Lippert Components, Inc., Elkhart, IN (US)

(72) Inventors: Scott C. MCKINNON, Union City, MI (US); David CROWDER, Osceola, IN (US)

(21) Appl. No.: 18/494,905

(22) Filed: Oct. 26, 2023

Related U.S. Application Data
(60) Provisional application No. 63/421,251, filed on Nov. 1, 2022.

(51) Int. Cl. E05B 79/06; E05B 83/44; E05B 85/18

(52) U.S. Cl. CPC E05B 79/06; E05B 83/44; E05B 85/18

(57) ABSTRACT

An entry door extension handle cooperable with a door latch assembly includes a main bracket securable to the door latch assembly, an extension bar connected to the main bracket, and an auxiliary bracket assembly connected to an end of the extension bar opposite from the main bracket. The extension bar is pivotable between a closed position and an open position. In the open position, the extension bar pivots the main bracket to an unlocked position. The auxiliary bracket assembly includes an auxiliary bracket configured for pivoting with the main bracket and the extension bar.

### CROSS-REFERENCES TO RELATED APPLICATIONS

This application claims the benefit of U.S. Provisional Patent Application No. 63/421,251, filed Nov. 1, 2022, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to an entry door and, more particularly, to an entry door extension handle cooperable with a door latch assembly for a recreational vehicle entry door.

Typical entry doors for recreational vehicles RV include a paddle latch that is a viable economical solution but may have ergonomic issues. The paddle latch can be a very small target for user hands, making it difficult for the user to get under the paddle to actuate the latch for door opening. The small target is an even greater hardship if the entry door incorporates a solid step in a stowed position, and the user is engaging the latch while standing on the ground. Leverage is difficult to achieve in this position.

Additionally, for some fifth wheel applications, the paddle latch can be situated very high off the ground, making it difficult for users to reach.

Some RV entry doors incorporate an auxiliary latch that is used in a situation where the entry door needs to be opened from the outside so that entry steps can be set up or deployed. In this case, the main door handle may be hard to reach or even fully out of reach depending on the RV design and the user's height. Existing double-latch entry door solutions may include a cable actuator between the latches, which is prone to breaking or failing and rendering the auxiliary latch inoperable.

### SUMMARY

The entry door extension handle of the described embodiments extends the target for operating the paddle latch by ten inches or more. The entry door extension handle creates added leverage for actuating the paddle latch, while also solving the problem of reach when there is no step in place. With an auxiliary door latch, the entry door extension handle of the described embodiments simplifies a connection between the lower (auxiliary) latch and the upper (main) latch into a rigid bar that mounts on the outside of the entry door. Each end of the bar can be built into the paddle-style RV door handles. Activating the lower latch applies a torsion to the bar which in turn activates the upper latch. The design creates a broader, easier grip that increases the leverage a user has for actuating the latches.

In an exemplary embodiment an entry door extension handle is cooperable with a door latch assembly and includes a main bracket securable to the door latch assembly, an extension bar connected to the main bracket, and an auxiliary bracket assembly connected to an end of the extension bar opposite from the main bracket. The extension bar is pivotable between a closed position and an open position. In the open position, the extension bar pivots the main bracket to an unlocked position. The auxiliary bracket assembly includes an auxiliary bracket configured for pivoting with the main bracket and the extension bar.

The door latch assembly may include a paddle-style door handle, and the main bracket may include a flat plate that overlies the paddle-style door handle. The door latch assembly may include a door handle, and the main bracket may include a flat plate that replaces the door handle. The auxiliary bracket assembly may include a base plate securable to an entry door, and the auxiliary bracket may be coupled with and pivotable relative to the base plate.

The door latch assembly may include a main door latch and an auxiliary door latch spaced from the main door latch, where the main bracket may be cooperable with the main door latch and the auxiliary bracket may be cooperable with the auxiliary door latch. In this context, the main bracket and the auxiliary bracket may be L-shaped brackets that connect upper and lower latch-engaging grips. The upper and lower latch-engaging grips may include respective flat plates that overlie the main and auxiliary door latches, respectively. The upper and lower latch-engaging grips may include an angled edge that locks into the main and auxiliary door latches, respectively, as an actuation hinge. The upper and lower latch-engaging grips each may include an elongated finger that acts as a stopper to limit a pivot range of the extension bar once the extension bar is pivoted to the closed position. The upper and lower latch-engaging grips and the extension bar may be formed of a monolithic molded or extruded piece.

The extension bar may include an angled or protruding proximal edge that acts as a hinge or cam surface.

The main bracket may include a cylindrical aperture to accommodate a main latch key lock.

In another exemplary embodiment, an entry door extension handle includes an extension bar, and a main bracket securable to the door latch assembly and connected to one end of the extension bar. The main bracket is pivotable with the door latch assembly. An auxiliary bracket connected to an opposite end of the extension bar is pivotally securable to the entry door. The extension bar is pivotable between a closed position and an open position, and in the open position, the extension bar pivots the main bracket to displace the door latch assembly to an unlocked position.

In yet another exemplary embodiment, a method of retrofitting an entry door extension handle on an entry door with an existing door latch assembly includes the steps of attaching a main bracket to an end of an extension bar; securing the main bracket to the existing door latch assembly; attaching an auxiliary bracket to an opposite end of the extension bar; connecting a base plate to the entry door; and pivotally connecting the auxiliary bracket to the base plate. The step of connecting the base plate to the entry door may include drilling holes in the entry door with a template, and securing the base plate with connectors through the holes.

### BRIEF DESCRIPTION OF THE DRAWINGS

These and other aspects and advantages will be described in detail with reference to the accompanying drawings, in which:

FIG. 1 shows an exemplary RV entry door incorporating the entry door extension handle of the described embodiments;

FIG. 2 shows the connection of the entry door extension handle to the main door latch assembly;

FIG. 3 shows an auxiliary bracket assembly connected to an opposite end of the extension bar;

FIG. 4 is a perspective view of the entry door extension handle;

FIG. 5 shows an exemplary application with a hand rail pivoted to a stowed position overlapping the entry door without impediment;

FIGS. 6 and 7 are opposite perspective views of the extension handle; and

FIGS. 8 and 9 show a variation of the entry door extension handle when used with an RV entry door including a main door latch and an auxiliary door latch.

### DETAILED DESCRIPTION

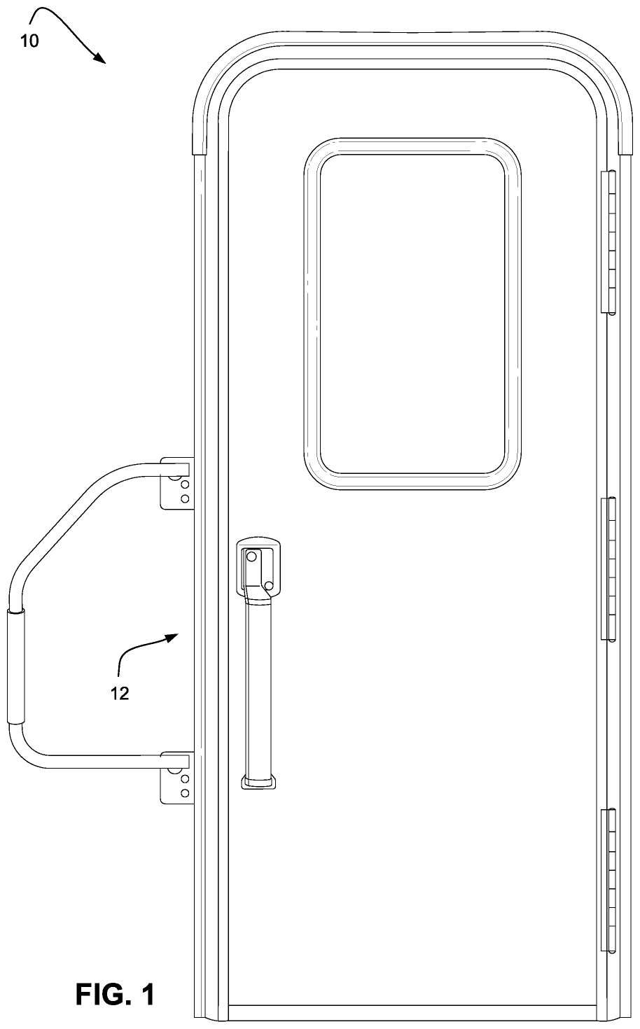

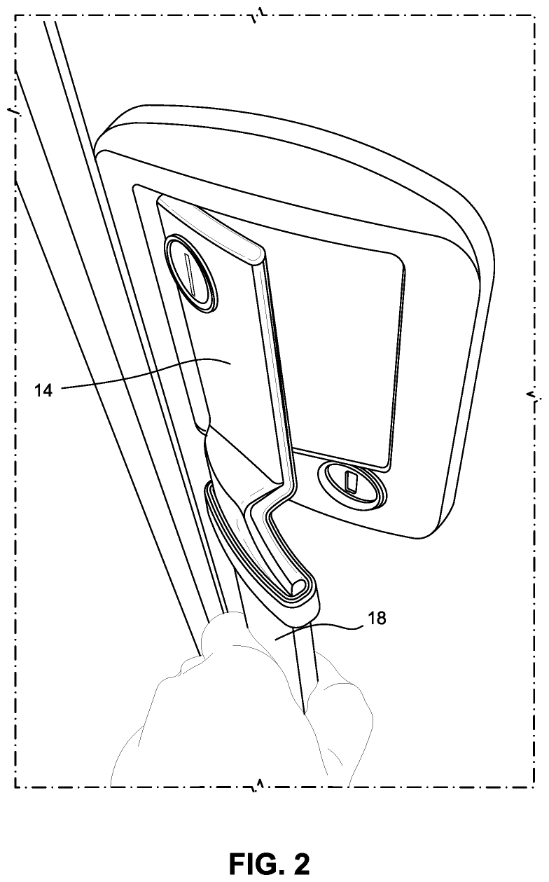

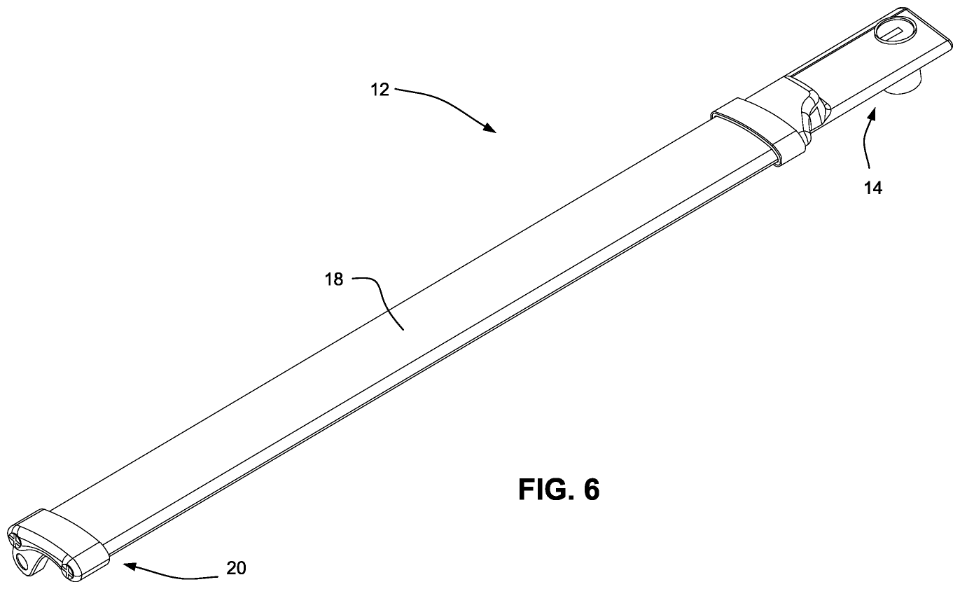

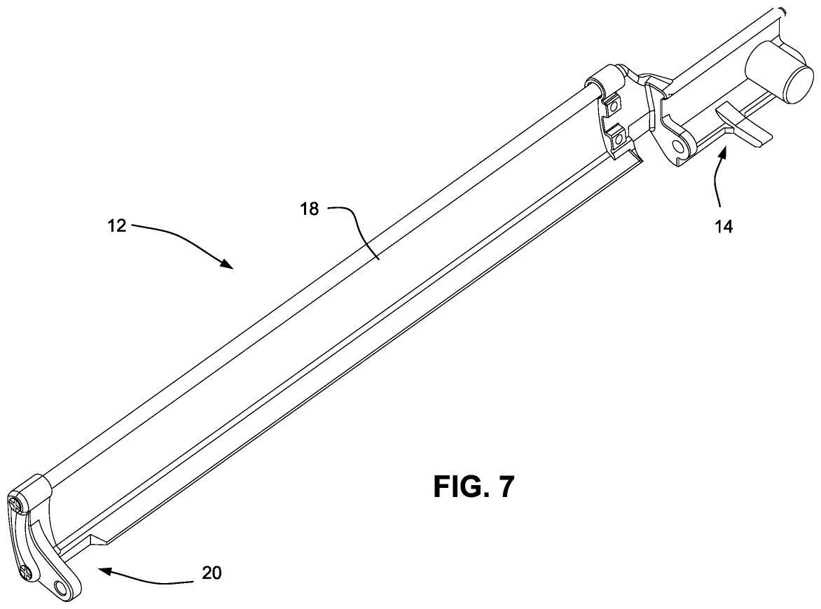

FIG. 1 shows an exemplary RV entry door 10 including an entry door extension handle 12 according to the described embodiments. With reference to FIGS. 2-4, the entry door extension handle 12 includes a main bracket 14 securable to an existing door latch assembly 16 of the RV entry door 10. An extension bar 18 is connected to the main bracket 14. As shown, the extension bar 18 is a generally flat elongated extension handle that serves as a gripping body. FIGS. 6 and 7 show opposite perspective views of the extension handle 12. The extension bar 18 may include a slightly angled or protruding proximal edge that can act as a hinge or camming surface (see, e.g., FIG. 7).

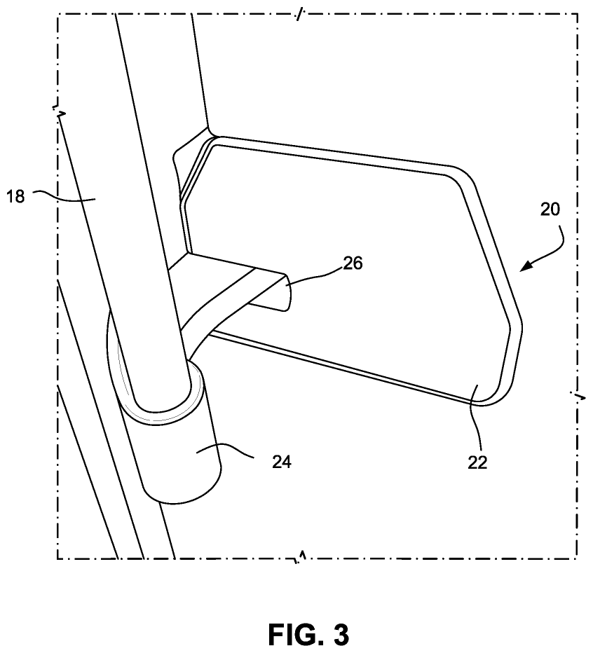

The entry door extension handle 12 may also be provided with an auxiliary bracket assembly 20 connected to an end of the extension bar 18 opposite from the main bracket 14. The auxiliary bracket assembly 20 includes a base plate 22 securable to the entry door and an auxiliary bracket 24 configured for pivoting with the main bracket 14 and the extension bar 18. In an exemplary construction, with reference to FIG. 3, the base plate 22 includes a slot 26 in which the auxiliary bracket 24 is disposed. The auxiliary bracket 24 is secured on a pivot point within the slot 26 and is thus displaceable in the slot with the extension bar 18.

In some configurations, the door latch assembly 16 includes a paddle-style door handle, where the main bracket 14 includes a flat plate that overlies the paddle-style door handle. Alternatively, the flat plate of the main bracket 14 may replace the existing door handle.

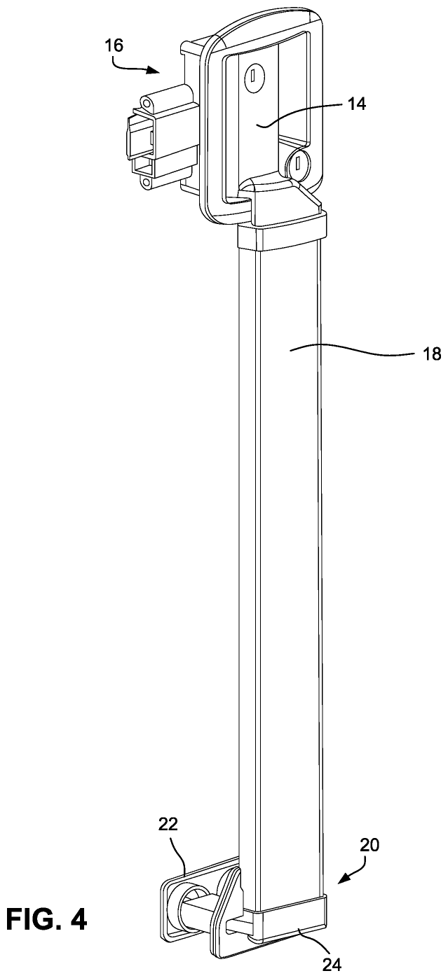

In use, the extension bar 18 is pivotable between a closed position (shown in FIG. 4) and an open position (shown in FIG. 2). In the open position, the extension bar 18 pivots the main bracket 14 to an unlocked position. That is, the extension bar 18 pivots the main bracket 14 so that the door latch assembly 16 is displaced to an unlocked position.

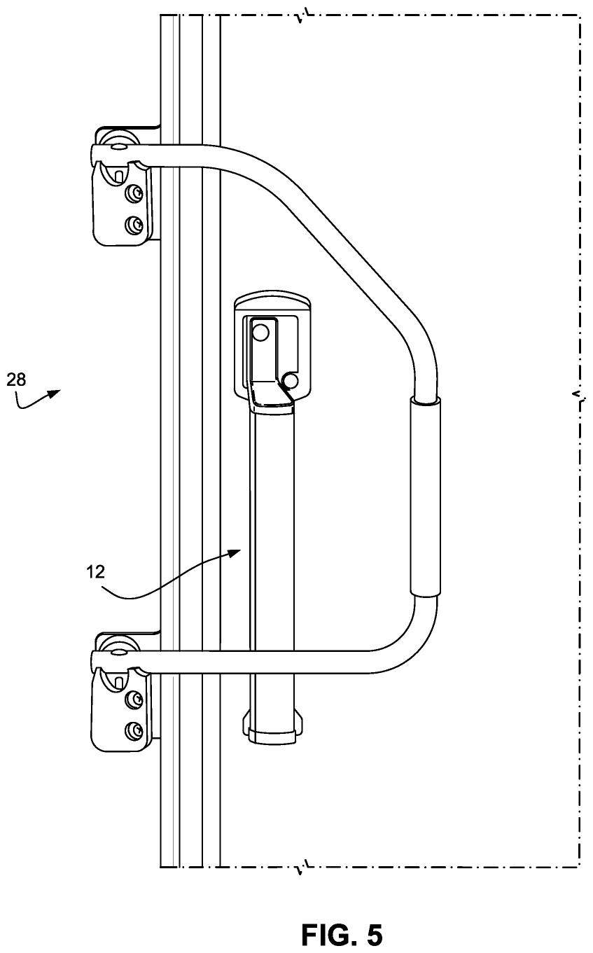

With reference to FIG. 5, the entry door extension handle 12 may be low-profile enough that a hand rail assembly 28 pivotally installed next to the RV entry door may pivot to the stowed position shown in FIG. 5 overlapping the entry door extension handle 12 without impediment.

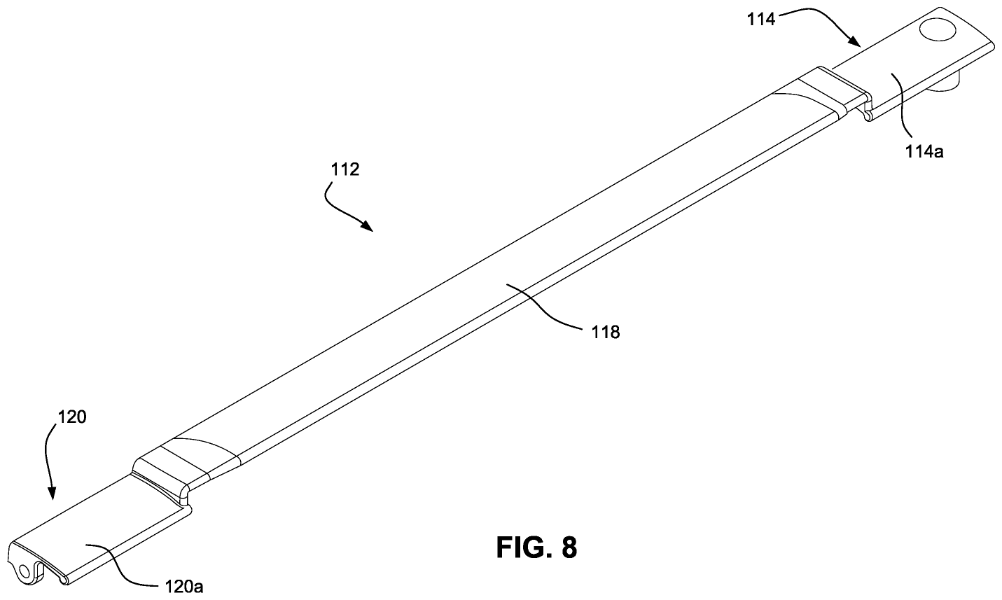

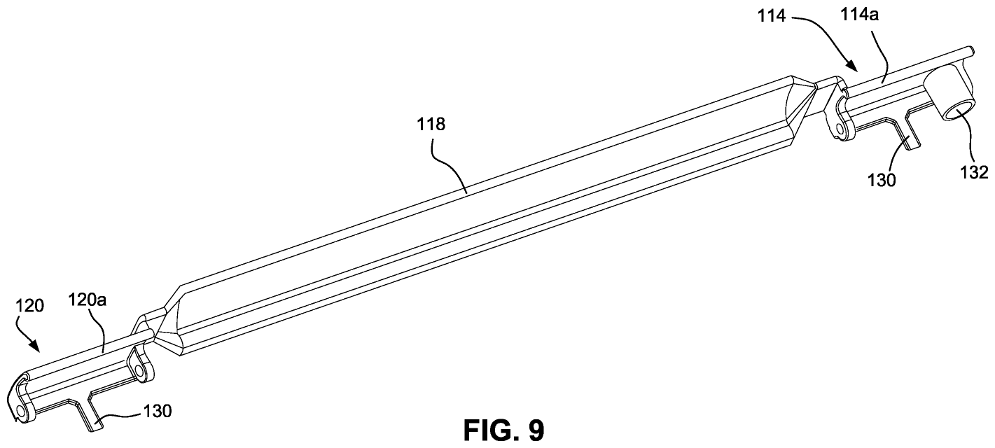

As noted above, some RV entry doors incorporate a main door latch and an auxiliary door latch that is typically positioned below the main door latch. FIGS. 8 and 9 show a variation of the entry door handle 112 that engages both the main and auxiliary door latches to actuate both latches at the same time to open the door. In this configuration, the main bracket 114 is cooperable with the main door latch, and the auxiliary bracket 120 is cooperable with the auxiliary door latch. The main bracket 114 and the auxiliary bracket 120 may be L-shaped brackets that connect upper and lower latch-engaging grips 114a, 120a. As shown, the upper and lower latch-engaging grips 114a, 120a may comprise respective flat plates that overlie the main and auxiliary door latches, respectively. In some embodiments, the upper and lower latch-engaging grips 114a, 120a include an angled edge that locks into the main and auxiliary door latches, respectively, as an actuation hinge. With reference to FIG. 9, the upper and lower latch-engaging grips 114a, 120a may each include an elongated finger 130 that acts as a stopper to limit a pivot range of the extension bar 118 once the extension bar 118 is pivoted to the closed position.

The main bracket 114 may be provided with a cylindrical aperture 132 to accommodate a main latch key lock.

In some embodiments, the upper and lower latch-engaging grips 114a, 120a and the extension bar 118 are formed of a monolithic molded or extruded piece. Additionally, the extension bar 18, 118 may be provided with an angled or protruding proximal edge that acts as a hinge or cam surface.

The entry door extension handle can be retrofitted to an existing door latch system with an auxiliary latch added in the aftermarket. A new front plate may be added to the main latch to better grip the extension handle, and two holes are drilled into the door using a template or the like to add a lower anchor for the auxiliary latch. In retrofitting the entry door extension handle, the main bracket 14, 114 is attached to an end of the extension bar 18, 118, and the auxiliary bracket 20, 120 is attached to an opposite end of the extension bar 18, 118. The base plate 22 is connected to the entry door. The main bracket 14, 114 is secured to the existing door latch assembly, and the auxiliary bracket 20, 120 is pivotally connected to the base plate 22.

The entry door extension handle of the described embodiments can extend the target for operating the existing paddle latch by ten inches or more. The design creates considerable leverage for actuating the paddle latch and solves reach/height problems when there is no step in place. Additionally, the entry door extension handle does not interfere with an exterior hand rail, and the assembly can be retrofitted to existing RV entry doors. With the application to entry doors including both main and auxiliary door latches, the design provides a broader easier grip that increases user leverage for actuating the latches. The design also eliminates issues with current double-latch entry door solutions that include a cable actuator between the latches, which is prone to breaking or failing and rendering the auxiliary latch inoperable.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An entry door extension handle cooperable with a door latch assembly, the entry door extension handle comprising:
a main bracket securable to the door latch assembly;
an extension bar connected to the main bracket; and
an auxiliary bracket assembly connected to an end of the extension bar opposite from the main bracket,
wherein the extension bar is pivotable between a closed position and an open position, wherein in the open position, the extension bar pivots the main bracket to an unlocked position, and wherein the auxiliary bracket assembly includes an auxiliary bracket configured for pivoting with the main bracket and the extension bar.

2. An entry door extension handle according to claim 1, wherein the door latch assembly comprises a paddle-style door handle, and wherein the main bracket comprises a flat plate that overlies the paddle-style door handle.

3. An entry door extension handle according to claim 1, wherein the door latch assembly comprises a door handle, and wherein the main bracket comprises a flat plate that replaces the door handle.

4. An entry door extension handle according to claim 1, wherein the auxiliary bracket assembly comprises a base plate securable to an entry door, and wherein the auxiliary bracket is coupled with and pivotable relative to the base plate.

5. An entry door extension handle according to claim 1, wherein the door latch assembly includes a main door latch and an auxiliary door latch spaced from the main door latch, and wherein the main bracket is cooperable with the main door latch and the auxiliary bracket is cooperable with the auxiliary door latch.

6. An entry door extension handle according to claim 5, wherein the main bracket and the auxiliary bracket are L-shaped brackets that connect upper and lower latch-engaging grips.

7. An entry door extension handle according to claim 6, wherein the upper and lower latch-engaging grips comprise respective flat plates that overlie the main and auxiliary door latches, respectively.

8. An entry door extension handle according to claim 6, wherein the upper and lower latch-engaging grips comprise an angled edge that locks into the main and auxiliary door latches, respectively, as an actuation hinge.

9. An entry door extension handle according to claim 6, wherein the upper and lower latch-engaging grips each comprises an elongated finger that acts as a stopper to limit a pivot range of the extension bar once the extension bar is pivoted to the closed position.

10. An entry door extension handle according to claim 6, wherein the upper and lower latch-engaging grips and the extension bar are formed of a monolithic molded or extruded piece.

11. An entry door extension handle according to claim 1, wherein the extension bar comprises an angled or protruding proximal edge that acts as a hinge or cam surface.

12. An entry door extension handle according to claim 1, wherein the main bracket comprises a cylindrical aperture to accommodate a main latch key lock.

13. An entry door extension handle cooperable with a door latch assembly that locks and unlocks an entry door, the entry door extension handle comprising:
an extension bar;
a main bracket securable to the door latch assembly and connected to one end of the extension bar, wherein the main bracket is pivotable with the door latch assembly; and
an auxiliary bracket connected to an opposite end of the extension bar, the auxiliary bracket being pivotally securable to the entry door,
wherein the extension bar is pivotable between a closed position and an open position, and wherein in the open position, the extension bar pivots the main bracket to displace the door latch assembly to an unlocked position.

14. An entry door extension handle according to claim 13, wherein the door latch assembly includes a main door latch and an auxiliary door latch spaced from the main door latch, and wherein the main bracket is cooperable with the main door latch and the auxiliary bracket is pivotally securable to the entry door via the auxiliary door latch.

15. An entry door extension handle according to claim 14, wherein the main bracket and the auxiliary bracket are L-shaped brackets that connect upper and lower latch-engaging grips.

16. An entry door extension handle according to claim 15, wherein the upper and lower latch-engaging grips comprise respective flat plates that overlie the main and auxiliary door latches, respectively.

17. An entry door extension handle according to claim 13, wherein the main bracket, the extension bar, and the auxiliary bracket are formed of a monolithic molded or extruded piece.

18. A method of retrofitting an entry door extension handle on an entry door with an existing door latch assembly, the method comprising:
attaching a main bracket to an end of an extension bar;
securing the main bracket to the existing door latch assembly;
attaching an auxiliary bracket to an opposite end of the extension bar;
connecting a base plate to the entry door; and
pivotally connecting the auxiliary bracket to the base plate.

19. A method according to claim 18, wherein the step of connecting the base plate to the entry door comprises drilling holes in the entry door with a template, and securing the base plate with connectors through the holes.
